(19) United States
(12) Patent Application Publication
(10) Pub. No.: US 2007/0261282 A1
(43) Pub. Date: Nov. 15, 2007

(54) Indoor modular panoramic signs

(76) Inventors: Reuvon Maman, Nahariya (IL); Israel Maman, Nahariya (IL)

Correspondence Address: Angenehm Law Firm, Ltd., P.O. Box 48755, Coon Rapids, MN, 55448-0755, US

(21) Appl. No.: 11/725,818

(22) Filed: Mar. 19, 2007

Related U.S. Application Data
(63) Continuation-in-part of application No. 11/037,873, filed on Jan. 18, 2005, now abandoned.
Application No. 11/037,873 is a continuation of application No. PCT/IL02/01033, filed on Dec. 24, 2002.

(30) Foreign Application Priority Data
Feb. 14, 2002 (IL) 148158

(51) Int. Cl. G09F 9/37

(52) U.S. Cl. 40/605

(57) ABSTRACT

A classification and characterization means for a sign is disclosed wherein the sign has a surface onto which an insert is received and a first guide. The classification and characterization means comprises member having a surface that correspond the surface of the sign and a second guide on the member wherein the second guide is slidably moving along the first guide. Classification and characterization means of different shapes and colors are mounted on sign's surface in order to distinguish between groups of different signs.

### FIELD OF THE INVENTION

The present invention relates to indoor signs. More particularly, the present invention relates to modular characterization and classification means for indoor panoramic signs.

This present application is a continuation in part of application number Ser. No. 11/037,873 filed on Jan. 18, 2005 which is a continuation of international application PCT/IL02/01033 filed on Dec. 24, 2002, which is a continuation of Israeli application number 148,158 filed Feb. 14, 2002 and entitled “Curves Element for Modular Sign Indoor”.

### BACKGROUND OF THE INVENTION:

Indoor panoramic signs are used in the art and are suspended adjacent to doors of organizations and other facilities so as to indicate the person that sits in a specific room, his position or other information regarding the use of a specific room or area. The signs are usually made of a metallic of plastic support onto which written information regarding the room or area is engraved.

During the years, the signs evolved to being modular in the sense that the support is not engraved with the information and instead, a sheet of paper or plastic is attached to it. The attached sheet with the written information can be easily altered without leaving marks on the support from glue or papers that are glued onto the signs, for example, since people are constantly moving and the rooms are constant. Therefore, the support is suspended adjacent to the door and the sheet of paper is changeable in a very simple manner.

However, there is a feature that has not been addressed until the present invention was developed and that feature involves the problem of classifying the signs, especially in large organizations. In large organizations, where there are several departments to the organization, the organization is spread on several floors or in several buildings; for example, there is a need to classify the signs so as to indicate a group of rooms according to a specific classification and characterization method.

### SUMMARY OF THE INVENTION

It is an advantage of the present invention to provide a classification and characterization method for modular panoramic signs.

It is another advantage of the present invention to apply a classification and characterization means on the signs that indicates groups of signs.

It is thus provided in accordance with the present invention, a classification and characterization means for a sign having a surface onto which an insert is received and at least one first guide, the classification and characterization means including:
at least one member having a surface that correspond the surface of the sign;
a second guide on said member wherein said second guide is adapted to slidably move along at least one of said at least one first guide;

whereby the classification and characterization means is mounted on the sign's surface in order to distinguish between groups of different signs.

Furthermore, in accordance with another preferred embodiment of the present invention, the sign is a panoramic sign and wherein the surface is a curved surface.

Furthermore, in accordance with another preferred embodiment of the present invention, said second guide comprises two slits that are provided on both sides of said at least one member

Furthermore, in accordance with another preferred embodiment of the present invention, two protrusions are provided on both sides of said at least one member and two slits are provided on both sides of said surface.

Furthermore, in accordance with another preferred embodiment of the present invention, said at least one member is design to hide a portion of the sign and reveal other portions.

Furthermore, in accordance with another preferred embodiment of the present invention, said at least one member can be designed in different shapes.

Furthermore, in accordance with another preferred embodiment of the present invention, said at least one member is colored in a different color of the sign.

Furthermore, in accordance with another preferred embodiment of the present invention, more than one classification and characterization means is mounted on the sign.

Furthermore, in accordance with another preferred embodiment of the present invention, said at least one member is made of a metallic material.

Additionally, in accordance with yet another preferred embodiment of the present invention, it is provided a classified sign including:
a sign having a surface adapted for graphics and at least one guide adapted to allow additional elements such as an insert to be engaged on said surface;
a classification and characterization means comprising at least one member having a corresponding surface that correspond said surface of the sign and at least one second guide on said at least one member, and wherein said classification and characterization means is adapted to be mounted on the sign.

### BRIEF DESCRIPTION OF THE FIGURES

In order to better understand the present invention and appreciate its practical applications, the following Figures are attached and referenced herein. Like components are denoted by like reference numerals.

It should be noted that the Figures are given as examples and preferred embodiments only and by no way limit the scope of the present invention as defined in the appending Description and Claims.

FIG. 1 illustrates an isometric view of a panoramic sign—prior art.

FIG. 2 illustrates an isometric view of a panoramic sign provided with classification and characterization means in accordance with a preferred embodiment of the present invention.

FIG. 3 illustrates an isometric and cross sectional view of a classification and characterization means in accordance with a preferred embodiment of the present invention.

FIG. 4 illustrates a frontal view of the panoramic sign shown in FIG. 2.

FIG. 5 illustrates an isometric view and side cross sectional view of a panoramic sign provided with classification and characterization means in accordance with another preferred embodiment of the present invention.

FIG. 6 illustrates frontal views on a plurality of panoramic signs provided with different types of classification means.

FIG. 7 illustrates an isometric view of a panoramic sign provided with classification and characterization means in accordance with yet another preferred embodiment of the present invention.

### DETAILED DESCRIPTION OF THE INVENTION AND FIGURES

The present invention provides a unique and novel classification and characterization means for panoramic signs that are usually used for indoor indication of rooms or areas in buildings. The new classification and characterization means can be manufactured onto the signs as will be indicated herein above; however can be also provided as an add-on classification and characterization means for existing panoramic signs in order to classify the signs.

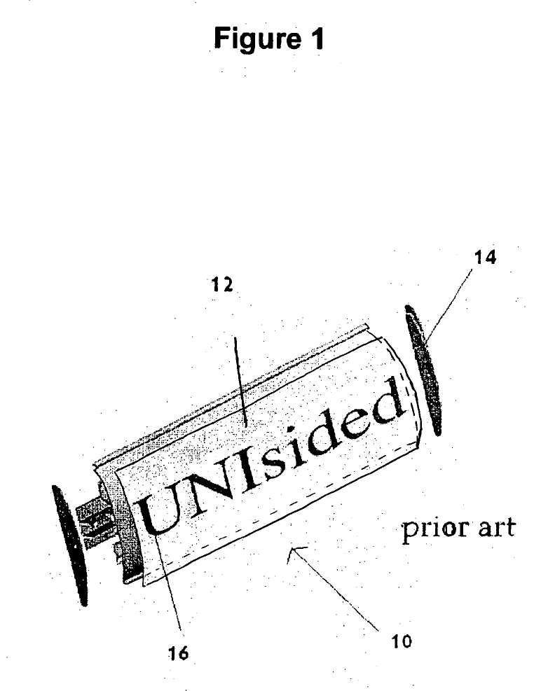

Reference is now made to FIG. 1 illustrating an isometric view of a panoramic sign —prior art. Panoramic sign 10 comprises a base 12 provided with a curved surface; however can be manufactured as a straight surface or in any other profile. Base 12 is preferably provided with two stoppers 14 adapted to be installed on both ends of the base. Graphics 16 is provided on the surface of base 12 and can be engraved on the surface or provided on a sheet of paper or plastic as an insert covered by a transparent covering so as to protect the graphics (the sheet of paper and covering is not shown in the Figures). In case of using a covering, stoppers 14 prevent movements of the paper as well as the covering.

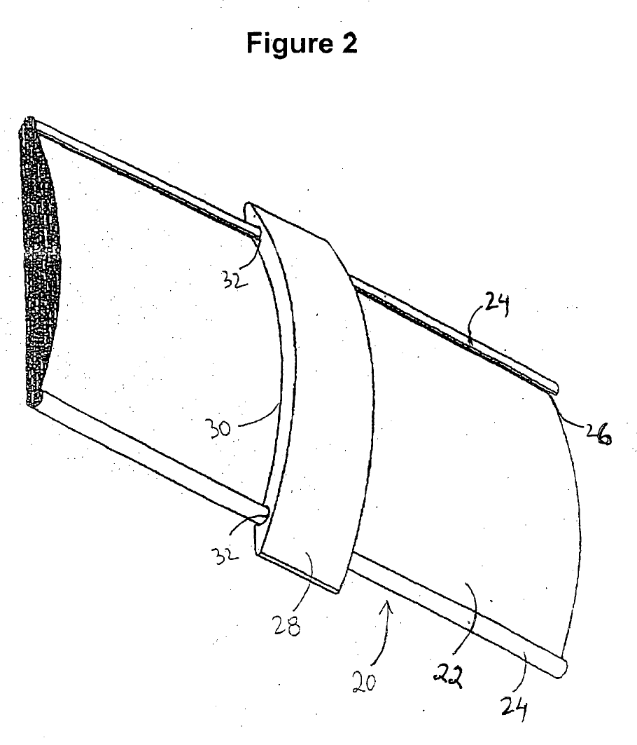

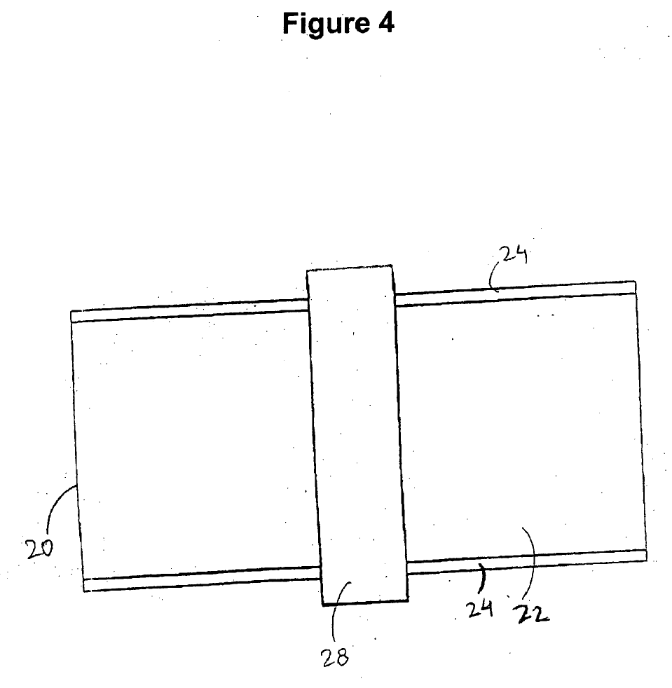

Reference is now made to FIGS. 2 and 4 illustrating isometric and frontal views, respectively, of a panoramic sign provided with classification and characterization means in accordance with a preferred embodiment of the present invention. Panoramic sign 20 is provided with a curved surface 22 bent in both sides so as to form a slotted guide 24. A slot 26 is adapted to receive the sheet with graphics and a covering, if necessary. A classification and characterization means 28 is designed to be a curved member that has an inner surface 30 corresponding the curvature of curved surface 22 of sign 20. Member 28 is provided with two slits 32 that correspond the profile of guide 24 of sign 20. Member 28 is a movable element adapted to slide on sign 20 and to be positioned in a specific positioning across surface 22 in front of surface 22 and in front of an insert or a cartridge that is used in prior art apparatus. Member 28 can be design in any design regarding color, width, shape, etc., as will be shown herein after. The classification method in accordance with the present invention is the use of a certain classification means for a group of rooms or areas. For example, in an organization, all rooms of management personnel can be indicated by a classification and characterization means having a certain color, while accounting department rooms are designated by another color of the classification means. In another example, if an organization is spread on 3 floors: the first floor can be designated by a sole member; the second floor can be designated by a double member and the third floor with three members as classification according to floors. The classification means is adapted to hide portions of the sign and to reveal other portions, therefore, it can be design to have any size and shape.

The classification means can be made of different materials; however, it is preferable to make a metallic classification means.

It should be noted that the classification and characterization means can be mounted on the sign in a slidable manner as shown herein; however, it can be attached by any other method such as gluing, screwing, or any other means. Stoppers can be used in order to avoid the classification and characterization means from sliding out of the sign.

It should be noted that the classification and characterization means of the present invention can utilize only one protrusion that is provided to the sign and slide with one slit onto the sign.

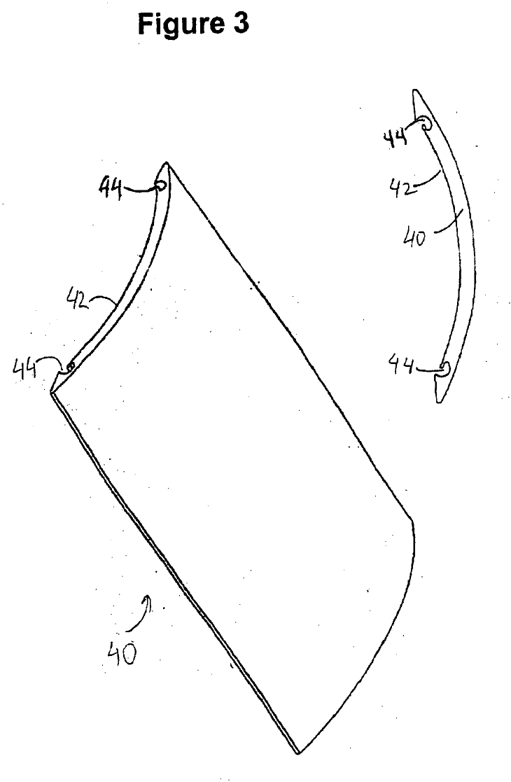

Reference is now made to FIG. 3 illustrating an isometric and cross sectional view of a classification and characterization means in accordance with a preferred embodiment of the present invention. Classification and characterization means 40 is a curved member having an inner curved surface 42 that correspond the curve of a regular panoramic sign. Inner curved surface 42 is provided with two guides in the shape of slits 44 on both sides that correspond protrusions of the panoramic sign. It should be noted that the classification and characterization means can be design to be an add-on element on an existing system of signs.

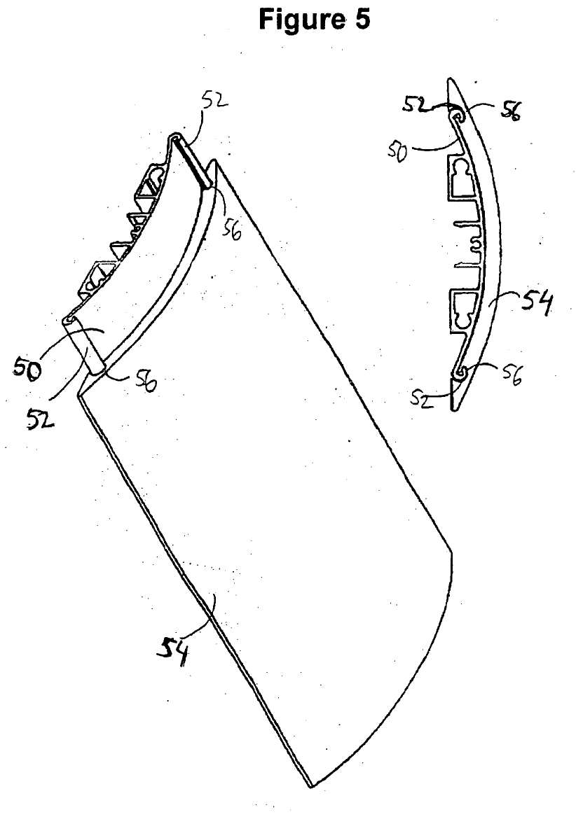

In order to better understand the engagement between the panoramic sign and the classification means, reference is now made to FIG. 5 illustrating an isometric view and side cross sectional view of a panoramic sign provided with classification and characterization means in accordance with another preferred embodiment of the present invention. Panoramic sign 50 is provided with two slotted protrusions 52 on both sides of the sign. Classification and characterization means 54 has a similar profile of sign 50 so that they can correspond to each other. Classification and characterization means is provided with two slits 56 that correspond protrusions 52 and can slide on top of sign 50. In the cross sectional view, the corresponding profiles of both sign 50 and classification and characterization means 54 is clearly shown.

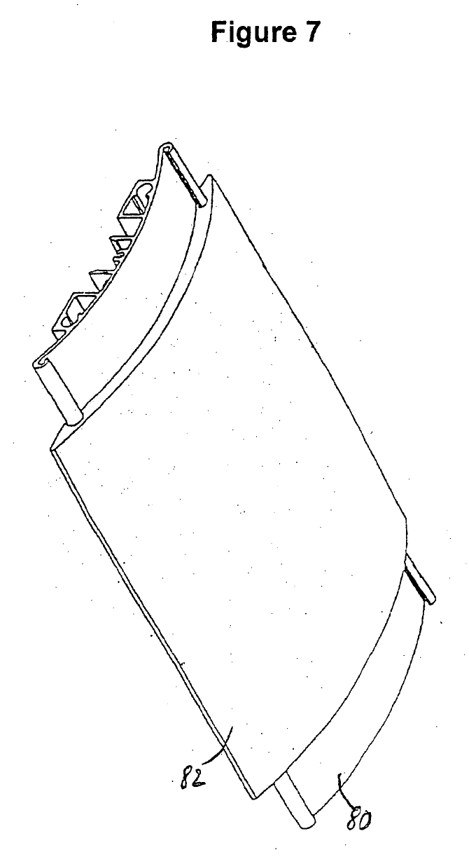

FIG. 7 illustrates an isometric view of a panoramic sign provided with classification and characterization means in accordance with yet another preferred embodiment of the present invention so as to clearly show the corresponding profiles of the sign 80 and the classification and characterization means 82.

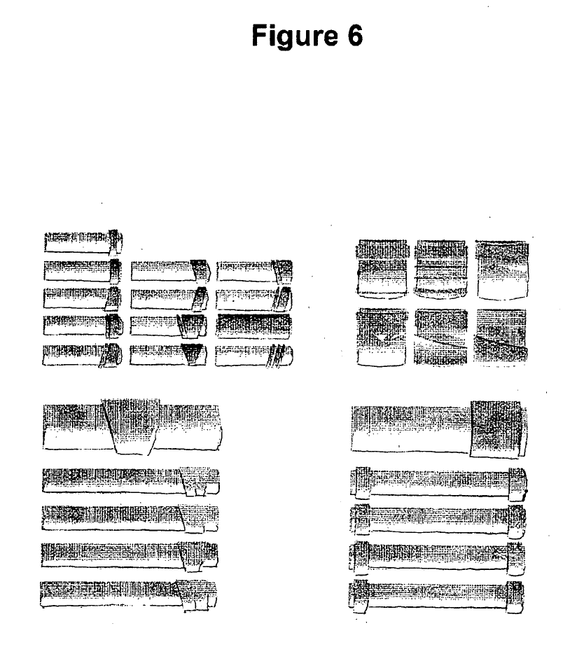

Reference is now made to FIG. 6 illustrating frontal views on a plurality of panoramic signs provided with different types of classification means. As mentioned herein before in the examples given for classification, each group of rooms or areas can be indicated by a different type of sign. The most obvious and visual classification is by differentiation of colors. Other differentiation can be by the use of different widths of the classification means, different shapes of the classification means, different positioning, or number of members that are provided as a classification means. It should be noted that any other use or combination of classification and characterization means can be utilized in the present invention and the examples given herein are by no means limit the scope of the present invention.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A classification and characterization means for a sign having a surface onto which an insert is received and at least one first guide, the classification and characterization means comprising:
at least one member having a surface that correspond the surface of the sign;
a second guide on said member wherein said second guide is adapted to slidably move along at least one of said at least one first guide;
whereby the classification and characterization means is mounted on the sign's surface in order to distinguish between groups of different signs.

2. The classification and characterization means as claimed in claim 1, wherein the sign is a panoramic sign and wherein the surface is a curved surface.

3. The classification and characterization means as claimed in claim 1, wherein said second guide comprises two slits that are provided on both sides of said at least one member.

4. The classification and characterization means as claimed in claim 1, wherein said at least one member is design to hide a portion of the sign and reveal other portions.

5. The classification and characterization means as claimed in claim 1, wherein said at least one member can be designed in different shapes.

6. The classification and characterization means as claimed in claim 1, wherein said at least one member is colored in a different color of the sign.

7. The classification and characterization means as claimed in claim 1, wherein more than one classification and characterization means is mounted on the sign.

8. The classification and characterization means as claimed in claim 1, wherein said at least one member is made of a metallic material.

9. A classified sign comprising:
a sign having a surface adapted for graphics and at least one guide adapted to allow additional elements such as an insert to be engaged on said surface;
a classification and characterization means comprising at least one member having a corresponding surface that correspond said surface of the sign and at least one second guide on said at least oen member, and wherein said classification and characterization means is adapted to be mounted on the sign.
